(19) United States
(12) Patent Application Publication
(10) Pub. No.: US 2023/0118161 A1
(43) Pub. Date: Apr. 20, 2023

(54) WATER FILTER WITH MODULE FOR QUICKLY DIAGNOSING FAULTY COMPONENT LOCATION

(71) Applicant: Mutosi Group Joint Stock Company (Mutosi Group, JSC), Ha Noi City (VN)

(72) Inventor: Van Diep Nguyen, Quang Ninh (VN)

(21) Appl. No.: 17/846,961

(22) Filed: Jun. 22, 2022

(30) Foreign Application Priority Data
Oct. 20, 2021 (VN) 2-2021-00434

(51) Int. Cl. B01D 61/12; B01D 61/02; C02F 1/44

(52) U.S. Cl. CPC B01D 61/12; B01D 61/025; C02F 1/441; C02F 2209/006; C02F 2209/10; C02F 2209/40; B01D 2313/18; B01D 2313/243

(57) ABSTRACT

The utility solution provides the reverse osmosis water purifier (Reverse Osmosis—RO), more specifically the RO water purifier using a module to assist in diagnosing and protecting the good status of the product to assist users to monitor the good status of the machine, assisting technicians in quickly diagnosing the location of faulty components on the system.

### BACKGROUND OF THE INVENTION

### Technical Field

The utility solution relates to the reverse osmosis water purifier (Reverse Osmosis—RO) having the module for quickly diagnosing the location of faulty components on the purifier.

### Background Art

Water plays an important role in maintaining human life because water directly affects our health, so the quality of daily drinking water is extremely important and needs to be paid top attention.

Currently, many water sources are polluted due to many different reasons, so water purification equipments are very popular in civil as well as in industry. Among the current water purification technologies, the RO filtration technology is capable of filtering many different input water sources such as well water, rain water, water from rivers.

The household water purifier applied the reverse osmosis technology for the purest water is available today. The product is equipped with a filter membrane with very small filter slots so that only water molecules can pass through while impurities will be trapped.

Currently, for systems, equipment, or residential RO water purifiers (for households) are assembled in the principle as shown in FIG. 3.

The input water is filtered by a filter cup No. 1, where large organic and inorganic impurities are retained by a filter core PP5. The water source, after being removed from the organic and inorganic impurities of large size, is pumped by the booster pump through a filter cup No. 2, where the water flow will be removed from organic impurities such as odors, strange tastes, . . . by the adsorption mechanism.

The water source treated with organic impurities in filter cup 2 is transferred to filter cup 3 by a compression mechanism pushed by a booster pump, where the feed water continues to be removed from inorganic impurities of the large size by the filter core PP1.

The feed water removed from organic and inorganic impurities by the first, second, and third prefilters are pressed onto the RO membrane, which is considered the heart of the reverse osmosis water purifier, and the RO membrane is a key component that determines the quality of the output water. Here, the input water flow is divided into 2 branches. The purified water branch is reverse osmosis through the RO membrane and enters the central water pipe of the RO membrane, and the pure water source is almost completely removed from organic impurities larger than 0.1 nanometer in size through the pressure boosting mechanism of the booster pump. The wastewater branch being the remaining water including dissolved solids, inorganic impurities is removed from the pure water flow, flows on the membrane surface and goes out via the wastewater line.

When the water purifier stops working, for the RO water membrane, usually, the residual water on the RO membrane is the wastewater with a higher concentration of dissolved solids than the input water stream. While this water flow will stay on the surface of the RO membrane, water-soluble solids that are left undisplaced will tend to precipitate and/or stick to the surface of the membrane.

With this cycle repeated many times after a long time of use, the quality of components in the filtration system will degrade over time including the first, second and third filter core, RO membrane, solenoid valves, pump, power supply, and users are difficult for understanding where the product is having problems, and what needs to be replaced, technicians spend a lot of time to figure out, replace and repair the product.

Therefore, there is a need for systems and devices to assist in informing users about the good status of the product, where on the product is having problems, thereby shortening the time to fix it.

### SUMMARY OF THE INVENTION

The utility solution aims to meet the above-mentioned needs.

Specifically, the utility solution provides the reverse osmosis water purifier having a module for quickly diagnosing the location of faulty components, wherein the module is constituted by:

a first water flow sensor 3 disposed in front of a pump 4 to measure the inlet water flow before the pump;

a first solenoid valve 2 at the water inlet, in which the first solenoid valve is located after a first filter cup (1) and before the first water flow sensor 3;

a second solenoid valve 9 at the water outlet, in which the solenoid valve is located in a drain line after a reverse osmosis filter membrane 7 and is installed in parallel with a control valve 8;

a second water flow sensor 10 to measure the water flow discharged from the filter, in which the second water flow sensor is located after the second solenoid valve 9 and the control valve 8;

a probe for measuring total dissolved solids located after the membrane 11;

a control circuit and a display circuit integrated on a circuit board, which receive signals from the water flow sensors as well as from the pump and control the executive components such as the solenoid valves, the high pressure valves, one-way valve and display instructions in combination with turning on lamps with different colors and sounds.

### BRIEF DESCRIPTION OF THE DRAWINGS

FIG. 1 shows the normal measurement control of the module for diagnosing and protecting the good status of the product.

FIG. 2 is the operating flow chart of the module for diagnosing and protecting the good status of the product.

FIG. 3 is a schematic diagram showing the components and assembly of the components as well as the inlet and outlet water lines of a conventional reverse osmosis water purifier.

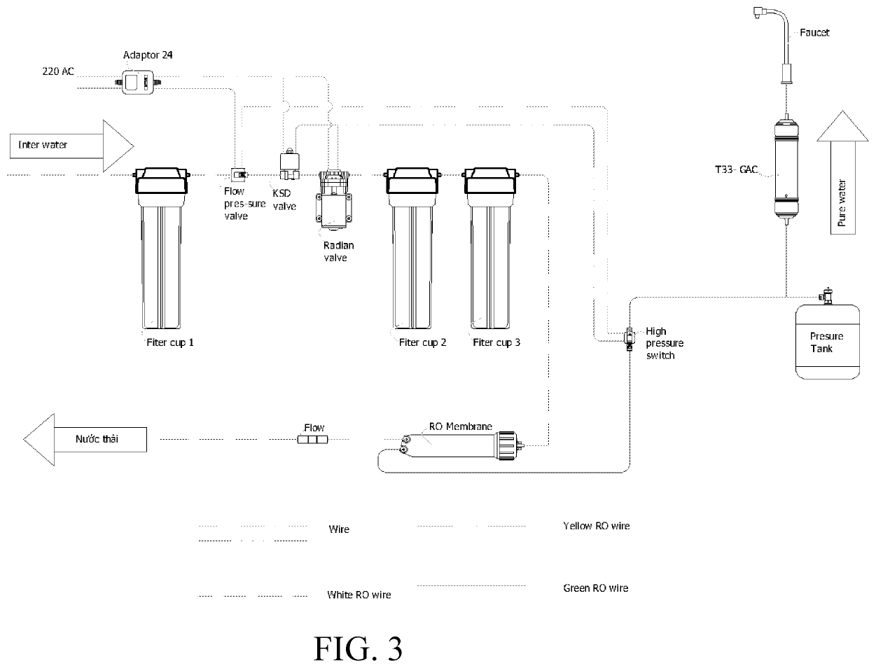

FIG. 4 is a schematic diagram showing the components and assembly of the components as well as the water inlet and outlet lines of the water purifier with integrated module for diagnosing and protecting the good status of the product according to the utility solution.

### DETAILED DESCRIPTION OF THE INVENTION

In the following, the utility solution will be described in more detail via a preferred embodiment with reference to the attached drawings. It should be understood that changes and modifications may be made without going beyond the scope of the disclosure and the following claims.

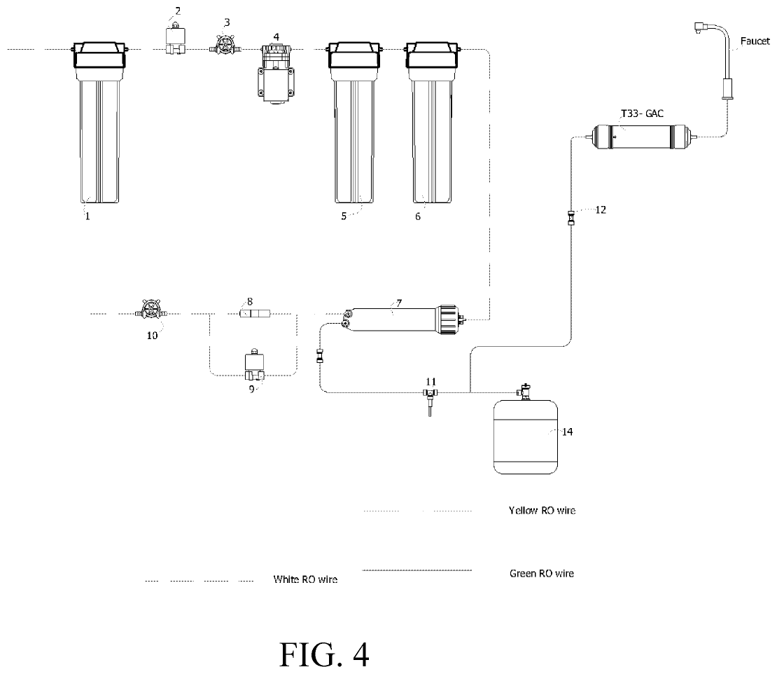

The structure of the water purifier according to the utility solution is shown in FIG. 4. Particularly, the water purifier according to the utility solution comprises the following components:

the first cup 1 for removing dirt larger than 5 μm in size;

the first solenoid valve 2 to open and close the water supplying to the water purifier;

the first water flow sensor 3 to measure the inlet water flow after the first filter cup;

the pump 4 to suck and push to pressurize water on the membrane;

the second cup 5 for filtering organic impurities;

the third cup 6 for removing dirt larger than 1 μm in size;

the reverse osmosis filter membrane 7 for filtering pure water;

the control valve 8 in combination with the pump 4 to pressurize water stably on the reverse osmosis filter membrane 7;

the second solenoid valve 9 acting as the discharge solenoid valve;

the second water flow sensor 10 is located after the assembly of the flow control valve 8 and the second solenoid valve 9 in the drain line;

the probe for measuring total dissolved solids located after the membrane (TDS electrode);

one-way valves 12, 15 before and after the pressure tank containing pure filtered water;

a high pressure valve 13 for shutting down the system when the pressure tank is full.

Accordingly, the module for quickly diagnosing the location of faulty components according to the utility solution is constituted by:

the first water flow sensor 3 disposed in front of a pump 4 to measure the inlet water flow before the pump;

the first solenoid valve 2 at the water inlet, in which the first solenoid valve is located after the first filter cup (1) and before the first water flow sensor 3;

the second solenoid valve 9 at the water outlet, in which the solenoid valve is located at the drain line after the reverse osmosis filter membrane 7 and is installed in parallel with the control valve 8;

the second water flow sensor 10 to measure the water flow discharged from the purifier, in which the second water flow sensor is located after the assembly of the second solenoid valve 9 and the control valve 8;

the probe for measuring total dissolved solids located after the membrane 11;

a control circuit and a display circuit integrated on a circuit board, which receive signals from the water flow sensors as well as from the pump and control the executive components such as the solenoid valves, the high pressure valves, one-way valve and display instructions in combination with turning on lamps with different colors and sounds.

System Operation

The water flow enters through the first filter cup 1, then through the first solenoid valve 2 in open status and the first water flow sensor 3 records the inlet water flow (LL1).

Next, the water flow is supplied to pump 4 and this pump pushes water through the second filter cup 5 and the third filter cup 6 to the reverse osmosis filter membrane 7 and from here the water flow is divided into two lines.

The first water line: wastewater flows through the flow control valve 8 and the second solenoid valve 9, then through the second water flow sensor 10 and this sensor records the outlet water flow (LL2)

The second water line: pure filtered water flows through the probe for measuring total dissolved solids located after the membrane to the pressure tank, 12-way check valve, functional core and to the faucet.

The module for quickly diagnosing the location of faulty components according to the utility solution monitors and evaluates based on: the inlet water flow (LL1), outlet water flow (LL2), current consumption on pump (Ip). The water flows LL1, LL2 represent the water circulation in the system: blockage, loss of water supply, etc. while Ip represents the water pressure after the pump. Standard RO parameters: standard RO parameters are standards for assessing the status of the system, which are directly expressed through LL1, LL2 and Ip.

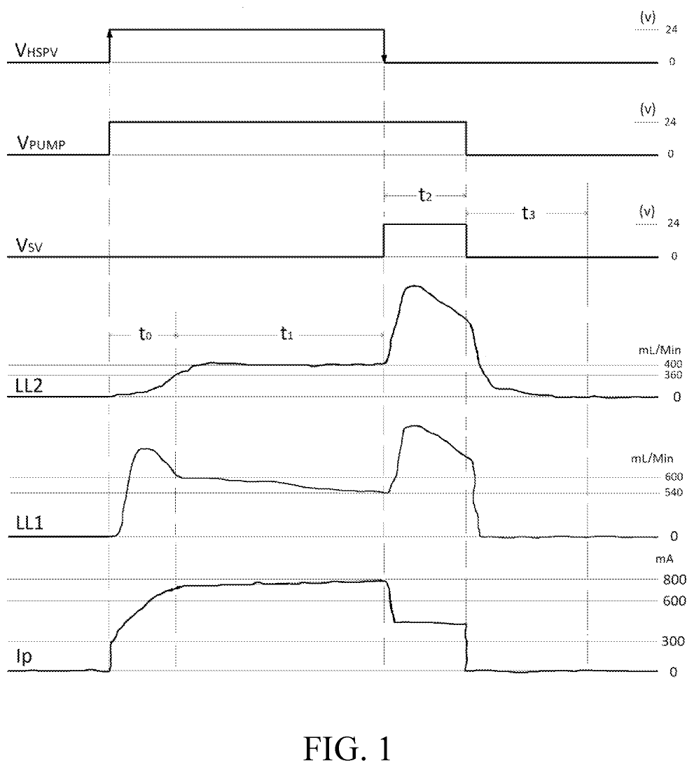

FIG. 1 shows the normal measurement control of the module for quickly diagnosing the location of faulty components according to the utility solution, trong [symbol] ó:

RO starting phase t0: pump 4 starts running until LL2˜400 ml/min, a good system t0 takes maximum within two minutes, Ip gradually increases from 450 mA up to 750 mA, LL1 increases rapidly up to 800 ml/min and then stabilized at 600 ml/min;

stable filter phase t1: lasts until the pressure tank is full, Ip gradually increases from 750 mA to 850 mA, LL1 gradually decreases to the threshold of 500 ml/min, and LL2 gradually increases to the maximum threshold of 450 ml/min;

discharging and flushing phase t2: taking 10 seconds, the pump 4 and the second solenoid valve 9 operate together, Ip runs at 450 mA, LL1 rises sharply above 800 ml/min and then reduces to 700 ml/min, LL2 spikes increased over 1000 ml/min and then down to 700 ml/min;

residual water phase t3: taking up to 6 min, the pump 4 and the second solenoid valve 10 shut off, Ip=0 immediately after the end of t2, LL1=0 right after the end of t2, LL2 gradually decreases from 250 ml/min to 0 ml/min in 5 minutes or less.

Parameters of the Standard RO System

An RO system at the beginning of the “stable filtration” process has the following values:

Inlet water flow (LL1): 600 ml/min

Outlet water flow (LL2): 400 ml/min

Pump current (Ip): 780 mA

Based on data from continuous measurement results, the module's standard RO parameter and “experience” for quickly diagnosing the location of the faulty components, the module will diagnose and react accordingly.

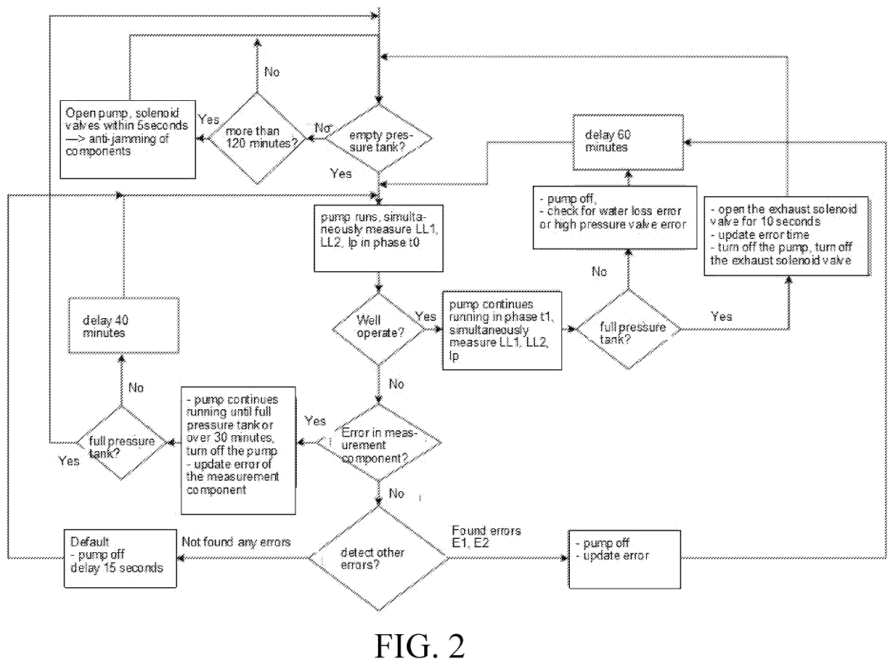

A operating cycle of the module for quickly diagnosing the location of a faulty component in the water purifier according to the utility solution includes: measuring, then predicting, and finally responding. The operating cycle repeats continuously. The operating flow chart of the module is shown in FIG. 2.

Measuring

Measuring water flow with an error of 5%, current with an tolerance of +/−50 mA

Phase t0: LL1, LL2, measure Ip at 40 points, diagnose error.

Phase t1: LL1, LL2, measure Ip at 40 points, diagnose errors and calculate RO membrane life.

Phase t2: LL1, LL2, measure Ip at 10 points, mainly to calculate the filter life of the first, second and third filter cups as well as the RO membrane washing function.

Diagnosing and Responding

Prediction and response of the module for quickly diagnosing the location of faulty components on the water purifier according to the utility solution shown in Table 1 below.

TABLE 1
Prediction and response of the module according to the utility solution

| | Deterministic | | Displaying |
|---|---|---|---|
| Prediction | conditions | Response | announcement |
| Normal | LL1 > 570 ml/min | calculate core | Playful announcement! |
| system | LL2 > 370 ml/min | time: 1, 2 + 3, | |
| | Ip > 700 mA | RO, CN1, CN2 | |
| | | count filtered | |
| | | traffic | |
| Error in the | 1 of 2 conditions: | Update error | Number displayed |
| measuring | LL1 = 0 ml/min or | P1 | P1 in red color |
| component | LL2 = 0 ml/min, where | Run the RO | Background “Icon |
| | Ip~750 mA | system in | Speaker” blinks C1 |
| | Ip < 300 mA | standard mode, | in red color |
| | | but take a break | Broadcast audio: |
| | | for 40 minutes | “measurement system is |
| | | if there is no | faulty, checking the |
| | | signal of full | following components: |
| | | pressure tank | first and second flow |
| | | | sensor, the pump, the |
| | | | solenoid valve” |
| Error of loss | LL1 < 200 ml/min | Update error E1 | Like P1 but display |
| of water | LL2 < 200 ml/min | Take a break | E1 |
| supply E1 | Ip < 500 mA | for 40 minutes, | Broadcast audio: |
| | “core life 1” > 80% | circulate | “the system has lost |
| | | checking the | water supply, please |
| | | new cycle | check your home |
| | | | water sypply, don't |
| | | | forget to check the |
| | | | following |
| | | | components: the |
| | | | solenoid valve, the |
| | | | pump” |
| | | | If the filter core time |
| | | | in the first filter cup |
| | | | is less than 70% |
| | | | “first number core” |
| | | | => Water supply is |
| | | | lost, the filter core is |
| | | | clogged in the first |
| | | | filter cup, solenoid |
| | | | valve is broken, |
| | | | pump is too weak |
| Clogging the | LL1 < 200 ml/min | Update error E2 | Like P1 but display |
| filter core in | LL2 < 200 ml/min | Take a break | E2 |
| the first filter | Ip < 500 mA | for 40 minutes, | Broadcast audio: |
| cup E2 | “filter core life 1” < | circulate | “the system has lost |
| | 70% | checking the | water supply due to |
| | | new cycle | the filter core in the |
| | | | first filter cup is |
| | | | clogged, please |
| | | | check your home |
| | | | water sypply, and |
| | | | then check the |
| | | | solenoid valve, the |
| | | | pump” |
| | | | => clogging the filter |
| | | | core in the first filter |
| | | | cup, loss of water |
| | | | supply, the solenoid |
| | | | valve is broken, the |
| | | | pump is too weak |
| Clogging the | LL1 > 300 ml/min | Update error E3 | Like P1 but display |
| control valve | LL2 < 100 ml/min | Take a break | E3 |
| | Ip > 800 mA | for 60 minutes, | Broadcast instruction |
| | Ip < 500 when the relief | circulate | audio: |
| | valve is open | checking the | “the system is |
| | | new cycle | clogged in the |
| | | | control valve” |
| Clogging the | LL1 > 300 ml/min | Update error E4 | Like P1 but display |
| filter core in | LL2 < 100 ml/min | Take a break | E4 |
| the second | Ip > 800 mA | for 60 minutes, | Broadcast audio: |
| and third | Ip > 600 when the relief | circulate | “the system is |
| filter cups | valve is open | checking the | clogged in the filter |
| | “filter core life 2-3” < | new cycle | core of the second |
| | 70% | | and third filter cups” |
| | | | => clogging the filter |
| | | | core in the second |
| | | | and third filter cups, |
| | | | the control valve and |
| | | | the second solenoid |
| | | | valve are broken |
| The weak | LL1 < 500 ml/min | Update error E5 | Like P1 but display |
| pump | LL2 < 350 ml/min | Take a break | E5 |
| | Ip < 600 mA | for 60 minutes, | Broadcast audio: |
| | “core life 1” > 80% | circulate | “the system may be |
| | | checking the | weaken in the pump, |
| | | new cycle | or ensure your |
| | | | home's water supply |
| | | | and check the pump” |
| | | | => the pump is |
| | | | weak, loss of water |
| | | | supply, the filter core |
| | | | clogged in the first |
| | | | filter cup |
| RO | LL1~500 ml/min | Update error E6 | Like P1 but display |
| membrane | LL2 > 400~450 ml/min | Take a break | E6 |
| clogged | Ip > 750 mA | for 60 minutes, | Broadcast audio: |
| | “RO mebrane's life” < | circulate | “the system is |
| | 70% | checking the | clogged in the RO |
| | | new cycle | membrane” |
| | | | => RO is clogged, |
| | | | one-way valve is |
| | | | clogged, the high |
| | | | pressure valves are |
| | | | broken |
| One-way | LL1~500 ml/min | Update error E7 | Like P1 but display |
| valve or the | LL2 > 400~450 ml/min | Take a break | E7 |
| high pressure | Ip > 750 mA | for 60 minutes, | Broadcast audio: |
| valves are | “the RO membrane's | circulate | “the system may be |
| clogged | life” > 80% | checking the | broken in the one- |
| | | new cycle | way valve or the |
| | | | high pressure valves” |
| Calculate the | LL1 − 700 ml/min | | |
| filter core life | LL1 measured in | | |
| in the first | discharging mode | | |
| filter cup | | | |
| Calculate the | (800 − Ip)/3, 5 | | |
| filter core life | Ip measured in | | |
| in the second | discharging mode | | |
| and third | | | |
| filter cups | | | |
| Calculate the | (LL1 − LL2)/2 | | |
| RO | LL1, LL2 measured in | | |
| membrane | the stable filtering cycle | | |
| life | | | |
| Error in the | LL2 > 200 ml/min | Update error E8 | Like P1 but display |
| solenoid | LL2 is measured in the | | E8 |
| valve broken | state of the full pressure | | Broadcast audio: |
| in the open | tank, in addition to the | | “the system is |
| state | “residual water phase” | | broken in the |
| | | | solenoid valve” |

1. A reverse osmosis water purifier having a module for quickly diagnosing the location of faulty components, wherein the module is constituted by:
a first water flow sensor (3) located in front of a pump (4) to measure the inlet water flow before the pump;
a first solenoid valve (2) at the water inlet, in which the first solenoid valve is located after a first filter cup (1) and before the first water flow sensor (3);
a second solenoid valve (9) at a water outlet, in which the solenoid valve is located in a drain line after a reverse osmosis filter membrane (7) and is installed in parallel with a flow control valve (8);
a second water flow sensor (10) to measure the water flow discharged from the filter, in which the second water flow sensor is located after the second solenoid valve (9) and the flow control valve (8);
a probe for measuring total dissolved solids located after the membrane (11);
a control circuit and a display circuit integrated on a circuit board, which receive signals from the water flow sensors as well as from the pump and control the executive components such as the solenoid valves, high pressure valves, one-way valve, and display instructions in combination with turning on lamps with different colors and sounds.
